(19) United States
(12) Patent Application Publication
(10) Pub. No.: US 2009/0150218 A1
(43) Pub. Date: Jun. 11, 2009

(54) MOBILE CONCIERGE SYSTEM AND METHOD

(75) Inventors: Ralph William Brunner, Bangkok (TH); Srinivas Malapaka, Singapore (SG); Tobias Julian Mason, West Sussex (GB)

Correspondence Address: Snell & Wilmer L.L.P. (AMEX), ONE ARIZONA CENTER, 400 E. VAN BUREN STREET, PHOENIX, AZ, 85004-2202, US

(73) Assignee: American Express Travel Related Services Company, Inc., New York, NY (US)

(21) Appl. No.: 12/269,459

(22) Filed: Nov. 12, 2008

Related U.S. Application Data
(60) Provisional application No. 61/012,109, filed on Dec. 7, 2007.

(51) Int. Cl. G06Q 30/00; G06Q 20/00; G06Q 40/00; G01C 21/00; G06Q 10/00

(52) U.S. Cl. 705/10; 705/14; 701/300; 701/213

(57) ABSTRACT

The system enables a consumer to receive promotional offers using a mobile communications device. The mobile communications device includes a client application that enables the consumer to assign preference levels associated with promotional offer categories. The mobile communications device transmits a consumer identifier, a location identifier, and preference levels to an application server. The application server uses the preference levels and other information included in a consumer profile associated with the consumer identifier to select promotional offers that are likely to be of interest to the consumer. The application server transmits map data including indicators of locations of local merchants to the mobile communications device. The client application causes the mobile communications device to display the map data, and enables the consumer to request promotional offers from selected merchants. The application server analyzes consumer request patterns and updates consumer profiles accordingly to improve subsequent selection of promotional offers.

### RELATED APPLICATIONS

This application claims priority to, and the benefit of, U.S. Provisional Ser. No. 61/012,109 filed on Dec. 7, 2007 and entitled “Mobile Concierge System and Method”, which is hereby incorporated by reference.

### FIELD OF THE INVENTION

The present invention generally relates to mobile communications, and more particularly to enabling consumers to receive customized promotional offers from local merchants on mobile communications devices.

### BACKGROUND

Merchants are often looking for new and innovative ways to promote their goods, services, information and the like (“items”) to consumers. One recent approach is to send advertisements via text messaging. In certain mobile advertising systems, consumers request to receive advertisements via text messaging. For example, a merchant could advertise a “short code” address and keywords in a traditional manner, e.g., on billboards or radio. A consumer could address a text message to the short code address and include one of the keywords in the body of the message to request text messages containing coupons related to the keyword. Using these systems, a mobile consumer may not know which merchants are located proximate to the mobile consumer's current location, or a consumer could receive a text message with a coupon that must be redeemed at a merchant located far away from the consumer.

Other mobile advertising systems allow consumers to specify a location of interest, for example by sending a zip code along with a keyword in the body of a text message. However, advertisements that are received in response are not customized to the consumer's particular interests or real-time location. For example, if the consumer requests advertisements for restaurants in an area, advertisements could be returned for restaurants that are of no interest to the consumer. Since consumers pay for text messaging services, such mobile advertising systems could result in increased costs to consumers with no added value.

Even if advertisements of potential interest to the consumer are received, text messages only provide a textual description of the goods or services advertised. Multimedia advertisements are likely to be much more effective for enticing consumers to visit the advertising merchant. For example, a color photograph or video of a product could stimulate interest in the product in ways that a simple test message could not.

There exists, therefore, a need to deliver promotional offers based on locations and interests of individual consumers. In addition, there exists a need to deliver high quality, multimedia promotional offers directly to mobile consumers.

### SUMMARY

The invention includes a method for providing a promotional offer to a mobile communications device based on a location of the mobile communications device. More specifically, the method comprises receiving a location identifier from the mobile communications device; selecting a promotional offer identifier based on the location identifier and preference information associated with at least one of: a consumer identifier and the mobile communications device; obtaining the promotional offer based upon the promotional offer identifier; and, transmitting the promotional offer to the mobile communications device. The preference information may also include a plurality of preference levels for categories of promotional offers. The method may also comprise determining whether a consumer is interested in receiving the promotional offer based on a category associated with the promotional offer identifier and the consumer preference information, or transmitting map data and/or a merchant indicator to the mobile communications device.

### BRIEF DESCRIPTION OF THE DRAWINGS

A more complete understanding of the invention may be derived by referring to the detailed description and claims when considered in connection with the Figures, wherein like reference numbers refer to similar elements throughout the Figures, and:

FIG. 1 illustrates a system, according to an embodiment of the present invention.

FIG. 2 illustrates a logical architecture of a system, according to an embodiment of the present invention.

FIG. 3 illustrates a flowchart of a process for selecting local promotional offers of interest to a consumer, according to an embodiment of the present invention.

FIGS. 4A-4F illustrate an exemplary implementation of the present invention.

FIG. 5 illustrates a block diagram of an exemplary computer system useful for implementing an aspect of the present invention.

### DETAILED DESCRIPTION OF EXEMPLARY EMBODIMENTS

The detailed description herein is presented for purposes of illustration only and not of limitation. For example, the steps recited in any of the method or process descriptions may be executed in any order and are not limited to the order presented. For the sake of brevity, conventional data networking, application development and other functional aspects of the systems (and components of the individual operating components of the systems) may not be described in detail herein. References to singular include plural, and references to plural include singular.

The present invention is directed to methods, systems, apparatuses, and computer program products for enabling delivery of promotional offers to mobile consumers based on the consumers' locations, interests, and transaction histories, for example. The present invention provides a convenient and reliable system and method for delivering promotional offers for local or other merchants likely to be of interest to individual mobile consumers.

In one embodiment, a client application may be downloaded to a mobile communications device (or previous exist on the device), such as a cellular telephone. A consumer may use the client application to request promotional offers from a server application, or the server may begin the process on its own. The server application determines an approximate location of the consumer based on a location of the consumer's mobile communications device, and returns promotional offers from local merchants likely to be of interest to the consumer.

A “merchant”, as used herein, may include any individual, business, entity, group, charity, software and/or hardware that desire to offers goods or services for sale. For example, a merchant may be a restaurant that wishes to offer a discount to consumers within a defined geographic proximity of the restaurant location.

A “consumer”, as used herein, may include any individual, business, entity, group, charity, software and/or hardware that desires to utilize the invention to obtain promotional items or purchase items from a merchant. It is noted that the terms “customer,” “consumer,” or “user” are used interchangeably herein.

It is further noted that a “mobile communications device” may include, for example, any of cellular telephones, beepers, pagers, iPods®, personal digital assistants (PDAs), Blackberry® type devices and/or any device capable of being moved from one location to another.

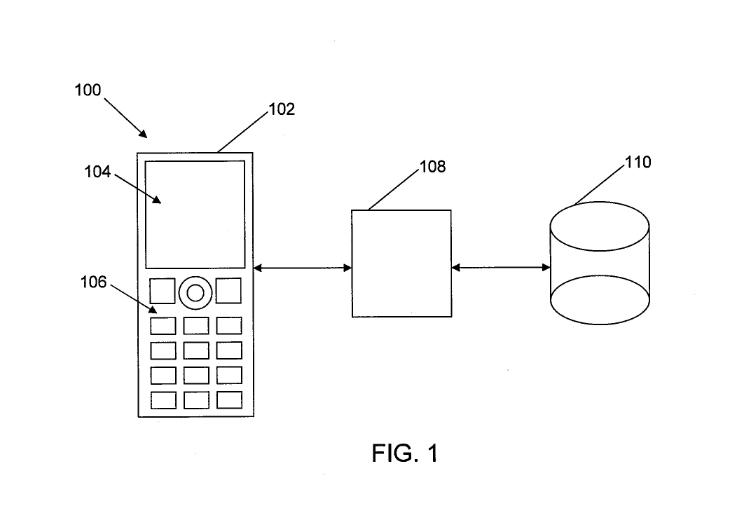

FIG. 1 illustrates a system 100 which enables local promotional offers to be delivered to mobile consumers who are likely to be interested in receiving them. System 100 includes a mobile communications device 102 having a display 104 and a keypad 106. In one embodiment, a client application (not illustrated) is installed on the mobile communications device 102. The client application may be installed before, during or after registration of mobile communications device 102 with an application server 108. The application server 108 executes a server application (not illustrated). The application server 108 selects one or more promotional offers from a database 110 based on the interests, location, transaction history, and purchase power of the consumer using the mobile communications device 102.

As will be appreciated by one of ordinary skill in the art, the present invention may be embodied as a customization of an existing system, an add-on product, upgraded software, a stand alone system, a distributed system, a method, a data processing system, a device for data processing, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

Computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

The consumer may register the mobile communications device 102 with application server 108. In one embodiment, the application server 108 sends an email message inviting a consumer to register. The email message may contain a phone number or a Universal Resource Locator (URL) of a web site to visit to complete a registration process.

Application server 108 may include any hardware and/or software suitably configured to facilitate processing transactions between mobile communications device 102 and database 110. Application server 108 may operate as a single entity in a single geographic location or as separate computing components located together or in separate geographic locations.

Further, application server 1108 may be an Internet server or may send, receive and process data via a network both to and from a separate Internet server.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the present invention. As those skilled in the art will appreciate, user computer may include an operating system (e.g., Windows NT, 95/98/2000, OS2, UNIX, Linux, Solaris, MacOS, etc.) as well as various conventional support software and drivers typically associated with computers. The computer may include any suitable personal computer, network computer, workstation, minicomputer, mainframe or the like. User computer can be in a home or business environment with access to a network. In an exemplary embodiment, access is through a network or the Internet through a commercially-available web-browser software package.

The computers discussed herein may provide a suitable web site or other Internet-based graphical user interface which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, Interbase, etc., may be used to provide an Active Data Object (ADO) compliant database management system.

Any of the communications, inputs, storage, databases or displays discussed herein may be facilitated through a web site having web pages. The term “web page” as it is used herein is not meant to limit the type of documents and applications that might be used to interact with the user. For example, a typical web site might include, in addition to standard HTML documents, various forms, Java applets, JavaScript, active server pages (ASP), common gateway interface scripts (CGI), extensible markup language (XML), dynamic HTML, cascading style sheets (CSS), helper applications, plug-ins, and the like. A server may include a web service that receives a request from a web server, the request including a URL (http://yahoo.com/stockquotes/ge) and an IP address (123.56.789). The web server retrieves the appropriate web pages and sends the data or applications for the web pages to the IP address. Web services are applications that are capable of interacting with other applications over a communications means, such as the internet. Web services are typically based on standards or protocols such as XML, SOAP, WSDL and UDDI. Web services methods are well known in the art, and are covered in many standard texts. See, e.g., ALEX NGHIEM, IT WEB SERVICES: A ROADMAP FOR THE ENTERPRISE (2003), hereby incorporated by reference.

During the registration process, the consumer is asked to provide information that uniquely identifies mobile communications device 102, which will be used to request and receive promotional offers. For example, the consumer may provide an International Mobile Equipment Identity (IMEI) associated with her mobile telephone. The consumer may be further asked to provide preference information regarding categories of promotional offers that she would like to receive. Preference levels are assigned to each category of promotional offers, based on the preference information supplied by the consumer. The consumer's preference information is stored in a consumer profile (not illustrated) in the database 110. The consumer may also provide the preference information using the client application to dynamically update the preference information using the mobile communications device 102. For example, promotional offers may be grouped into categories such as shopping, dining & entertainment, health & beauty, membership rewards, golf, and travel. Subcategories may be associated with the categories of promotional offers. The shopping category may consist of subcategories, including: books, music & media, clothing & fashion, electronics & office equipment, food & wine, gifts, hobbies, toys, & sports, home & garden, jewelry & accessories; and service, for example.

In one embodiment, the consumer may receive promotional offers on other mobile communications devices such as, for example, a mobile communications device belonging to a family member. System 100 may be instructed as to which mobile communications device to send promotional offers. The instruction may be provided when a consumer enters an identifier using the device keypad, for instance, and causing the device to transmit a device identifier and consumer identifier to system 100. In another embodiment, the consumer may interface with system 100 through a web site to modify an identifier for the mobile communications device.

In one embodiment, the consumer may be alerted by way of mobile communications device 102 when promotions become available. For example, an auto dealer may schedule a promotion, whereby a limited number of cars are offered for purchase at a substantial discount. A participating consumer may interact with application server 108 to view an upcoming promotion and elect to be alerted when the promotion is launched. When the promotion is launched, the consumer is alerted by way of email, text message, telephone call, and/or the like. The consumer may secure an opportunity to purchase the auto at the discount rate by returning an email, text message, telephone call, and/or the like indicating a desire to purchase the auto. Based on the consumer's position relative to the responses received and the limited number of autos, the consumer may secure the opportunity to purchase the auto at the discount rate. For more information related to mobile commerce relative to scheduled promotions, see U.S. application Ser. No. 11/741,077, “System and Method for Facilitating Mobile Commerce”, filed on Apr. 27, 2007; the entire contents which is hereby incorporated by reference.

In another embodiment, notice of a promotional offer may include an offer to issue the consumer an incentive or loyalty points, if the consumer chooses to accept the promotional offer. For example, a promotional offer from a restaurant may include an offer to double the number of membership rewards if the consumer accepts the offer within twenty-four hours. Accordingly, a promotional offer may include an offer to increase to point-to-currency ratio on rewards that are redeemed for the offer. For example, a sporting goods store may offer to double the value of a consumer's membership rewards toward a purchase of a particular tennis racket.

Using the client application executing on mobile communications device 102, the consumer updates her preference information. In one embodiment, the categories of promotional offers are displayed on display 104. The consumer uses the keypad 106, or other input device, to order the categories according to her preferences. For example, the consumer may place the membership rewards category at the top of display 104, indicating that the consumer has the highest preference for this category. Other categories may be ordered below, in order of relative preferences. Further, categories may be hidden, indicating that the consumer does not prefer to receive promotional offers in those categories. The client application or the consumer then assigns corresponding preference levels to each category, and mobile communications device 102 transmits the preference levels to application server 108, which stores the information in the customer's profile located in database 110.

In one embodiment, other databases may be accessed to determine consumer preferences. Such databases may include, for example, a transaction history database, a billing database, and a database from a third-party. A third-party may comprise a merchant who supplies purchase data, for example, that may be used to determine the consumer's preferences. A billing database may be accessed, for example, to determine which merchants the consumer frequents or to determine the consumer's purchasing power. An authorization database may be accessed to determine transactional patterns. For example, analysis of an authorization database may indicate that most of the consumer's credit card purchases occur on Saturdays, between 10:00 am and 7:00 pm.

Any databases discussed herein may be any type of database, such as relational, hierarchical, graphical, object-oriented, and/or other database configurations. Common database products that may be used to implement the databases include DB2 by IBM (White Plains, N.Y.), various database products available from Oracle Corporation (Redwood Shores, Calif.), Microsoft Access or Microsoft SQL Server by Microsoft Corporation (Redmond, Wash.), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one aspect of the present invention, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In one exemplary embodiment, the ability to store a wide variety of information in different formats is facilitated by storing the information as a BLOB. Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with the financial transaction instrument by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments of the present invention, the data can be stored without regard to a common format. However, in one exemplary embodiment of the present invention, the data set (e.g., BLOB) may be annotated in a standard manner when provided for manipulating the data onto the financial transaction instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a stand alone interaction device configured to add, delete, modify, or augment the data in accordance with the header or trailer. As such, in one embodiment, the header or trailer is not stored on the transaction device along with the associated issuer-owned data but instead the appropriate action may be taken by providing to the transaction instrument user at the stand alone device, the appropriate option for the action to be taken. The present invention may contemplate a data storage arrangement wherein the header or trailer, or header or trailer history, of the data is stored on the transaction instrument in relation to the appropriate data.

One skilled in the art will also appreciate that, for security reasons, any databases, systems, devices, servers or other components of the present invention may consist of any combination thereof at a single location or at multiple locations, wherein each database or system includes any of various suitable security features, such as firewalls, access codes, encryption, decryption, compression, decompression, and/or the like.

The firewall may include any hardware and/or software suitably configured to protect the various disclosed resources from users of other networks and provide limited or restricted access to the consumer. The firewall may reside in varying configurations including Stateful Inspection, Proxy based and Packet Filtering among others. The firewall may be integrated within server 108, any other system components or may reside as a separate element.

In one embodiment, the consumer's profile also contains information that is supplied by the consumer during registration. The customer may supply information regarding types of transaction cards used by the consumer. For example, the consumer could specify that he has a Centurion® card from American Express, and a card type field in the consumer's profile is updated accordingly. Some merchants may provide special promotional offers to consumers who have this type of card, as these consumers are likely to have relatively large disposable incomes and, thus, are more likely to take advantage of certain promotional offers.

When the consumer requests promotional offers, application server 108 uses information in the consumer's profile to select potential promotional offers and filter out promotional offers that are not of interest to the consumer. Thus, the consumer receives only promotional offers that he is likely to have an interest in receiving. In this regard, if the consumer routinely receives promotional offers that are of great interest to him, he is likely to request more promotional offers in the future.

In discussing the logical architecture of the various system components herein, the present invention may be described in terms of functional block components, screen shots, optional selections and various processing steps. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. In addition to the above mentioned protocols and languages, the software elements of the present invention may be implemented with any programming or scripting language such as C, C++, Java, COBOL, assembler, PERL, Visual Basic, SQL Stored Procedures, extensible markup language (XML), with the various algorithms being implemented with any combination of data structures, objects, processes, routines or other programming elements. Further, it should be noted that the present invention may employ any number of conventional techniques for data transmission, signaling, data processing, network control, and the like. Still further, the invention could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

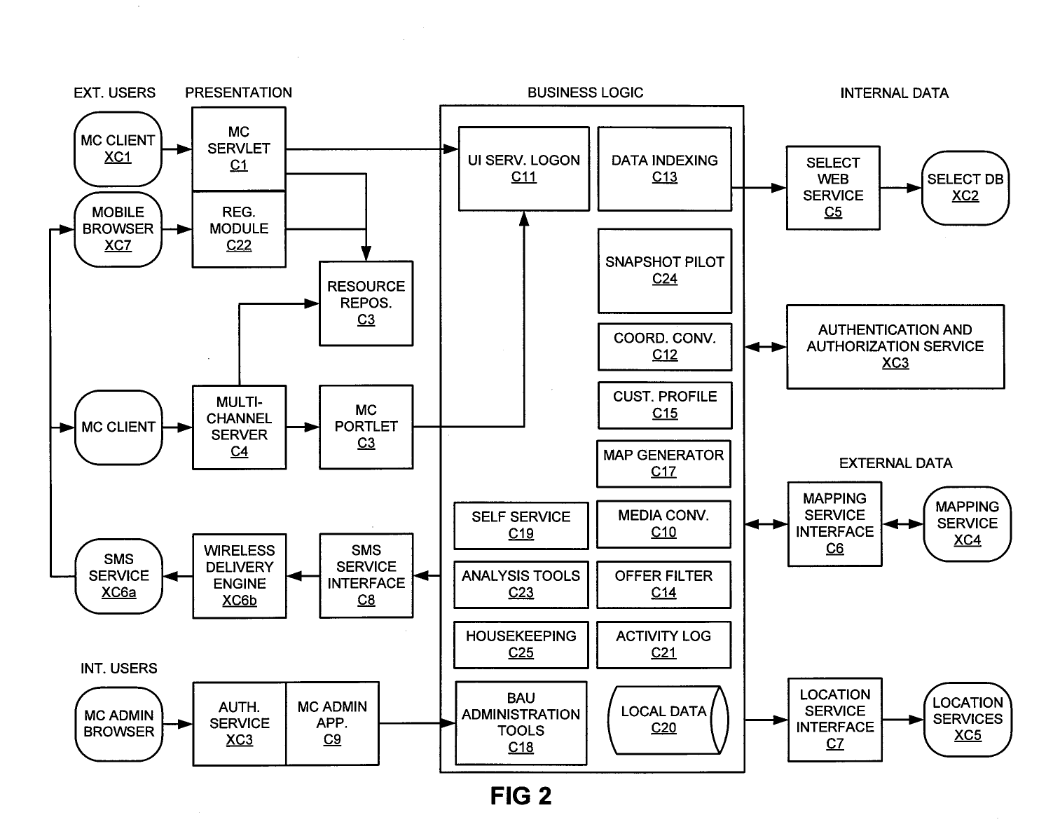

A logical architecture of the server application that is executed by the application server 108, according to one embodiment of the invention, is described with reference to FIG. 2. Of course, one skilled in the art will recognize that various components of the server application software could be executed on a plurality of application servers 108, and that a plurality of databases 110 may be used. In one embodiment, the logical architecture of the server application executed by application server 108 is partitioned into three logical layers: a Presentation Layer, a Business Logic layer, and an external Data Layer. The Presentation Layer includes software components that provide various interfaces between external entities and the Business Logic Layer.

The Business Logic Layer includes a Flash® Lite™ Servlet Software Component C1 that converts Hypertext Transfer Protocol (HTTP) “Gets” requests to Service Oriented Architecture Protocol (SOAP) format, and SOAP formatted items to name value pairs and attachments. The Flash® Lite™ Servlet Software Component C1 communicates via Secure HTTP (HTTPS) with a Flash® Lite™ Software Component XC1 that executes on the mobile computing device 102. The Flash® Lite™ Servlet Software Component C1 is implemented using Java 2 Platform, Enterprise Edition (J2EE) servlets and Extensible Stylesheet Language Transformations (XSLT).

The Presentation Layer also includes a Web Administration Software Component C9, which facilitates administration of the server application via a web browser. The Administration Web Software Component C9 is implemented using J2EE Java Server Pages (JSP). The Administration Web Software Component C9 communicates with an Authentication and Authorization Service Software Component XC3, which is implemented using the Lightweight Directory Access Protocol (LDAP).

The Presentation Layer further includes a Registration Module Software Component C22, which facilitates registration of consumers. In one embodiment, the Registration Module Software Component C22 is implemented using J2EE and JSP. The Registration Module Software Component C22 communicates via HTTPS with a Mobile Web Browser Software Component XC7 that executes on the mobile computing device 102.

The Presentation Layer may also include a Portlet Software Component C3 that communicates via HTTPS with a WebSphere Portal Multi-Channel Server (MCS) Software Component C4. The WebSphere Portal MCS Software Component C4 translates aggregated portlets into multiple protocols. The WebSphere Portal MCS Software Component C4 also communicates via HTTPS with a WebSphere Everyplace Mobile Portal Client Software Component that executes on the mobile computing device 102. As persons skilled in the art will appreciate, other schemes for implementing portals may be used, including Java Enterprise Server.

The Business Logic Layer includes a variety of software components that are used to select and deliver promotional offers to mobile consumers. The Business Logic Layer includes a Service Software Component C2, which is implemented using J2EE, and is used to coordinate a plurality of Business Logic Layer software components, which are described below. The Business Logic Layer also includes a Media Conversion Software Component C10 that facilitates conversion of media in one format to another format. For example, media files used to present promotional offers could be stored in a Moving Picture Experts Group (MPEG) format, and converted into a Flash® format prior to delivery to consumers.

The Business Logic Layer further includes a User Interface (UI) Services Software Component C11 that facilitates consumer logon. Once logged on, the User Interface (UI) Services Software Component C11 allows a consumer to query available promotional offers in various categories. The User Interface (UI) Services Software Component C11 also allows the consumer to change information in the user's profile, such as a preference levels associated with interest categories.

The Business Logic Layer also includes a Coordinate Conversion and Conversion Cache Software Component C12 that facilitates conversion of consumers' location indicators into corresponding coordinates. The Coordinate Conversion and Conversion Cache Software Component C12 also coordinates caching of coordinates conversions, which helps to improve response time by making frequently requested coordinate conversions readily available. For example, the coordinates that correspond to a particular network cell identifier (Cell ID) are cached and used for subsequent requests for promotional offers that originate from that Cell ID.

The Business Logic Layer further includes a Data Indexing Software Component C13 that facilitates storage and retrieval of promotional offers that are stored in the database 110. For example, a promotional offer for a complimentary appetizer or desert with a purchase of an entrée to could be indexed by the Data Indexing Software Component C13 to facilitate later retrieval

Another component of the Business Logic Layer is an Offer Filtering Software Component C14 that removes certain promotional offers from a list of potential promotional offers generated for a consumer. The Offer Filtering Software Component C14 applies business rules to determine which promotional offers should be removed from the list of potential promotional offers. For example, if a merchant associated with a promotional offer identifier is within a predefined distance from the consumer's location, it is added to the list of potential promotional offer identifiers. In one embodiment, the Offer Filtering Software Component C14 would remove the promotional offer identifier from the list if a business rule specifies that the customer must have a Centurion® card from American Express to receive this offer, and the customer does not have this card.

The Business Logic Layer also includes a Customer Profile Software Component C15 that facilitates creation of customer profiles and modification of information stored therein. For example, Customer Profile Software Component C15 allows a customer to set his interest preference levels so that he only receives promotional offers in the golf category.

Another component of the Business Logic Layer is a Resource Repository Software Component C16, which facilitates storage and retrieval of files that are delivered to consumers for presentation of promotional offers. The Resource Repository Software Component C16 facilitates storage of a plurality of multimedia files types, including image files and video files.

The Business Logic Layer also includes a Map Generation and Caching Software Component C17, which facilitates creation of map data for various locations where a consumer requests promotional offers. For example, a merchant indicator or symbol is added to a map at a location corresponding to a merchant's location, which is associated with a promotional offer. The Map Generation and Caching Software Component C17 also coordinates caching of map data, which helps to improve response time by making frequently requested map data readily available.

The Business Logic Layer also includes an Administration Tools Software Component C18 that allows an administrator to create, read, update, and delete customer profiles, user access settings, and business rules.

The Business Logic Layer further includes a Local Database Software Component C20 that facilitates access to the database 110. The Local Database Software Component C20 is a relational database management system implemented in DB2.

The Business Logic Layer also includes an Activity Log Software Component C21 that facilitates logging consumers' activity to create transaction histories, which are analyzed by an Analysis Tools Software Component C23. The Analysis Tools Software Component C23 generates reports based on consumer activities, which can be reviewed to determine the effectiveness of promotional offers. For example, a report could include the most or least requested promotional offer from a particular merchant, which could help the merchant create more effective promotions in the future.

In various embodiments, the Analysis Tools Software Component C23 communicates with the Consumer Profile Software Component C15 to update preference levels in a consumer's profile based on the consumer's transaction history. For example, if the Analysis Tools Software Component C23 determines that the consumer requests promotional offers from restaurants serving French cuisine more often than other categories of restaurants, the consumer's preference information could be modified so that promotional offers from restaurants serving French cuisine are given priority over promotional offers for other types of restaurants. By virtue of this feature, the consumer is likely to have greater satisfaction with the service and, thus, is likely to request promotional offers more frequently.

The External Data Layer provides an interface between software components of the Presentation Layer and external data sources. The External Data Layer includes a Mapping Service Interface Software Component C6 that communicates via HTTP and SOAP with a Mapping Service Software Component XC4 of a geographical information service provider, such as AGIS Software, for example. The Mapping Service Interface Software Component C6 provides coordinates to the Mapping Service Software Component XC4 and receives corresponding map data.

The External Data Layer also includes a Location Service Interface C7 that provides a location identifier to a Location Services Software Component XC5 of a geographical information service provider, such as AGIS Software, for example, and receives corresponding coordinates in response. In some embodiments, Location Service Interface Software Component C7 provides a network Cell ID based on Location Based Services (LBS) to the Location Services Software Component XC5, and receives corresponding coordinates in response. In some embodiments, the location identifier includes Global Positioning System (GPS) coordinates; Location Service Interface Software Component C7 provides the GPS coordinates to Location Services Software Component XC5, and, in response, receives corresponding coordinates in another coordinate system, such as the Universal Transverse Mercator (UTM) coordinate system.

In accordance with one embodiment, Location Service Interface Software Component C7 includes logic to more accurately pinpoint the consumer's location through a triangulation process. For example, as a consumer moves about a city, Location Service Interface Software Component C7 receives a first cell tower identifier, stores the first identifier, receives a second cell tower identifier, stores the second identifier, and so on. By receiving and storing multiple cell tower identifiers, system 100 is able to more accurately determine the location of the consumer. The consumer may activate and deactivate the feature as desired.

In another embodiment, the described triangulation process may be modified over time to further increase location accuracy. For example, Location Service Interface Software Component C7 may be configured to track the four most recently received cell tower identifiers, and later configured to track the ten most recently received cell tower identifiers. Moreover, the configuration of Location Service Interface Software Component C7 may be modified in accordance with a location type. As such, the number of cell tower identifiers that are tracked and used in determining the consumer's location may be modified by geographic areas based on such factors, for example, as population density, cell tower density, number of participating merchants and service providers, cell transmission protocol, and the like.

Practitioners will appreciate that other known methods of determine the location of the mobile communications device may be implemented including, for example, GPS satellite system signal, Network Assisted GPS, Enhanced Observed Time Difference methods, Cell Global Identity Timing Advance, and Uplink Time of Arrival. Moreover, it should be appreciated that the features described herein may be performed by the various components and systems also described herein. For example, features disclosed as being performed at mobile communications device 102, may be performed at application server 108 without departing from the scope of the invention.

In one embodiment, Location Service Interface C7 provides a location identifier such that when an item is purchased using Mobile Communications Device 102, Application server 108, or any other component of system 100, may determine the appropriate taxing authority. For example, as the consumer travels from Phoenix to New York, the consumer may choose to purchase theatre tickets offered as a promotion from a Broadway theatre. The location identifier determines the consumer's location, determines the appropriate taxing authorities, and adds the appropriate tax amount to the purchase price of the tickets. For more information related to wireless taxation transactions, see U.S. application Ser. No. 09/255,456, entitled “Transaction Tax Settlement in Personal Communications Devices”, filed on Feb. 15, 2002; the entire contents which is hereby incorporated by reference.

Practitioners will appreciate that communication between the various disclosed components, as well as the LBS to determine the location of mobile communications device 102 may use any network hardware, software, and protocols known now or in the future. As used herein, the term “network” shall include any electronic communications means which incorporates both hardware and software components of such. Communication between a mobile device and Communication among the parties in accordance with the present invention may be accomplished through any suitable communication channels, such as, for example, a telephone network, cellular telephone network, an extranet, an intranet, Internet, point of interaction device (point of sale device, personal digital assistant, cellular phone, kiosk, etc.), online communications, satellite communications, off-line communications, wireless communications, transponder communications, local area network (LAN), wide area network (WAN), networked or linked devices, keyboard, mouse and/or any suitable communication or data input modality. Moreover, although the invention is frequently described herein as being implemented with TCP/IP communications protocols, the invention may also be implemented using IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

Moreover, while frequently discussing communications of the mobile device as being facilitated through a cellular network, it is contemplated that such communications may be provided through any known and/or future communications networks. For example, the mobile device may communicate with any of the disclosed systems and components by way of wireless local area networks (WLAN) such as Wi-Fi.

The various system components may be independently, separately or collectively suitably coupled to the network via data links which includes, for example, a connection to an Internet Service Provider (ISP) over the local loop as is typically used in connection with standard modem communication, cable modem, Dish networks, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

As used herein, “transmit” may include sending electronic data from one system component to another over a network connection. Additionally, as used herein, “data” may include encompassing information such as commands, queries, files, data for storage, and the like in digital or any other form

Referring again to FIG. 2, the External Data Layer further includes a Short Message Service (SMS) Service Interface Software Component C8 that is used to provide requests for SMS delivery of data to a Wireless Delivery Engine (WDE) Software Component XC6b via SOAP. Wireless Delivery Engine Software Component XC6b forwards the data via HTTPS to a vendor responsible for generating SMS messages, such as Air2Web, Inc., for example. SMS messages are received by a SMS Service Software Component XC6a, which executes on mobile communications device 102. For example, the client application is downloaded to mobile communications device 102 via the SMS Service Interface C8, WDE Software Component XC6b, and the SMS Service Software Component XC6a.

Practitioners will appreciate that the invention is not limited to the details shown in FIG. 2, and various modifications can be readily envisioned. For example, the functionality of various software components could be combined, such as the functionality of the Activity Log Software Component C21 and the Analysis Tools Software Component C23. Further, a variety of different protocols and software applications can be used, for example WebSphere, J2EE, Java Enterprise Server, Lightweight Java, and the like, as will be appreciated by persons skilled in the art.

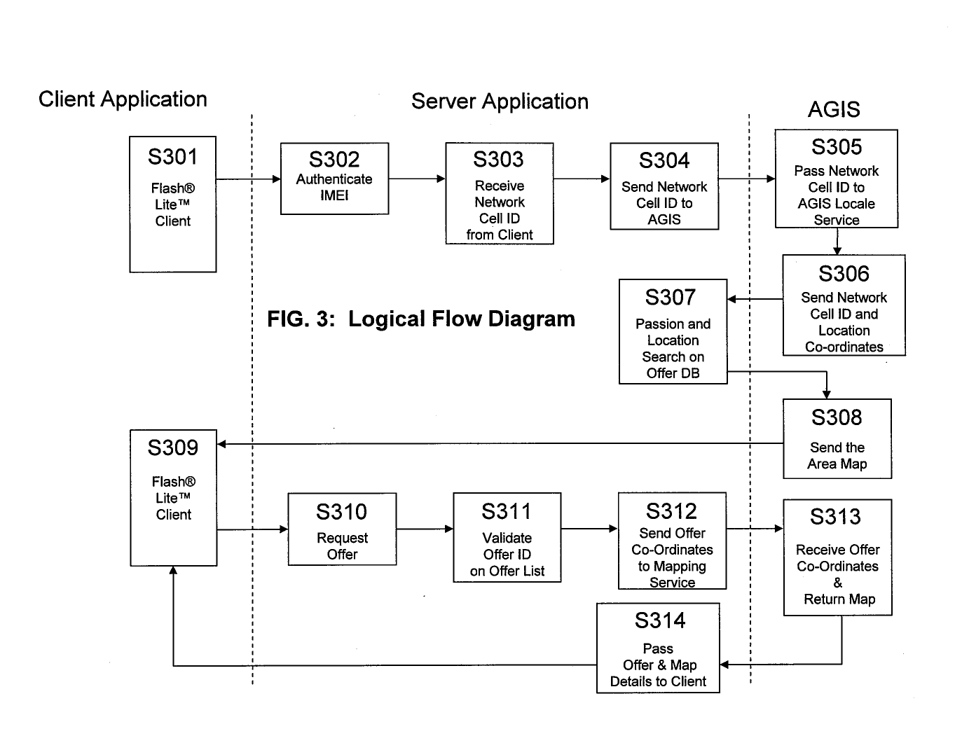

FIG. 3 illustrates a process for requesting, selecting, and delivering promotional offers to a consumer according to an embodiment of the present invention. Initially, in step S301, mobile communications device 102 transmits a consumer identifier to the application server 108. In step S302, application server 108 authenticates the consumer identifier. For example, the application server 108 verifies that consumer identifier is included in a list of registered consumer identifiers.

In step S303, application server 108 receives the location identifier from the mobile communications device 102. The location identifier is transmitted to an external geographical information service provider, in step S304. The geographical information service provider determines coordinates that correspond to the location identifier, in step S305. In step S306, the coordinates are returned to the application server 108.

In step S307, applications server 108 identifies promotional offers from merchants located within a predetermined distance from the consumer's coordinates, and filters out promotional offers that are determined not to be of interest to the consumer. For example, each participating merchant's location is geo-coded such that an exact street address and data regarding an “X” and “Y” crossing of lines of a latitude and a longitude are stored in database 110. Application server 108 queries database 110, and identifies merchants located within a search distance of 1,000 meters from the consumer's coordinates. If no merchants are identified, the search distance could be increased to 2,000 meters, for example, in rural areas where merchants are highly geographically dispersed. Potential promotional offers from local merchants are identified. The application server 108 receives preference information from the consumer's profile to identify categories of promotional offers that the consumer has an interest in receiving, and filters the potential promotional offers accordingly. Once a list of promotional offers of interest to the consumer is generated, coordinates corresponding to merchants offering these promotional offers are transmitted to the external geographical information service provider.

In step S308, the geographical information service provider generates map data for an area in the vicinity of the consumer. Merchant indicators are added to the map data at locations corresponding to the local merchants offering promotions of interest to the consumer. The map data is then transmitted to mobile communications device 102.

In step 309, the consumer reviews the map data to ascertain the locations of merchants offering promotions. If the consumer would like to receive a promotional offer from one of these merchants, the consumer causes mobile communications device 102 to send a request for a particular promotional offer to application server 108. The request includes a promotional offer identifier corresponding to the merchant selected by the consumer.

In step S310, the application server 108 receives the promotional offer identifier. In step 311, application server 108 verifies that the promotional offer identifier is valid. For example, applications server 108 verifies that the promotional offer identifier is included in a list of valid promotional offer identifiers. Coordinates corresponding to the merchant associated with the promotional offer identifier are transmitted to the geographical information service provider, in step S312.

In step S313, the geographical informational service provider generates map data for an area in a vicinity of the merchant and provides same to the application server 108. In step S314, application server 108 transmits the map data, information regarding the promotional offer requested, and information regarding the merchant to mobile communications device 102.

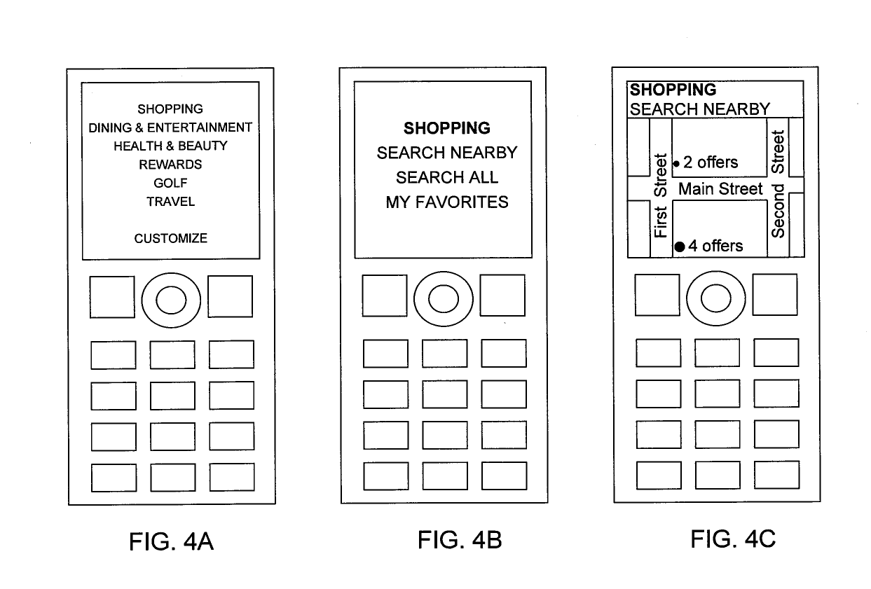

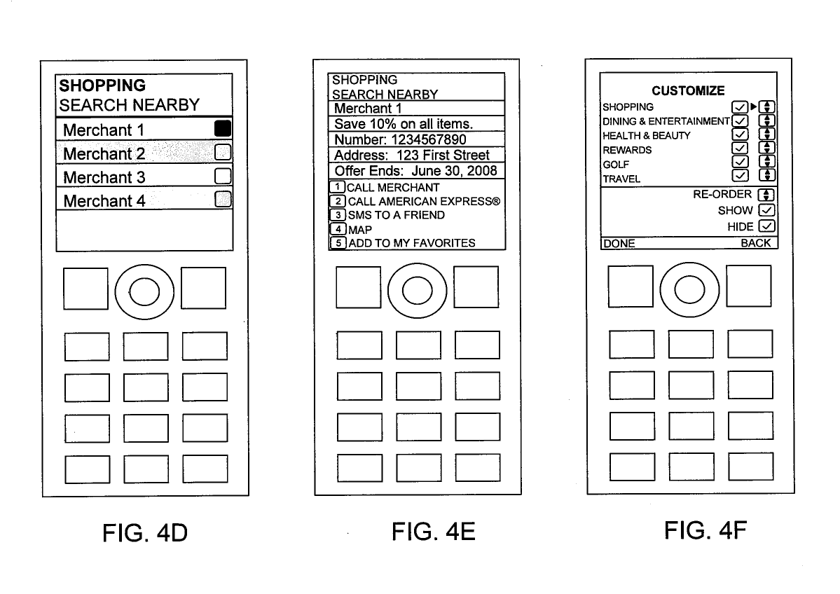

An example implementation of the present invention is described with reference to FIGS. 4A-4F. The client application causes a screen, as shown in FIG. 4A, to be displayed on the display 104 of mobile communications device 102. The consumer has an option of selecting, for example, one of six categories of promotional offers. The consumer also has an option to customize her preferences for receiving promotional offers in each of the categories, as will be described with reference to FIG. 4F.

FIG. 4B illustrates a screen that is presented on the display 104 when the consumer selects “SHOPPING” on the screen shown in FIG. 4A. The consumer has an option to select “SEARCH NEARBY” to search for local merchants offering promotions in the shopping category. The consumer also has an option to select “SEACH ALL” to search for all merchants offering promotions in the shopping category. In addition, the consumer has an option to select “MY FAVORITES” to review previously stored promotional offers in the shopping category. The consumer uses the keypad 106 to make selections. In addition, the display 104 could be a touch screen display that allows the consumer to make selections using the display 104.

FIG. 4C illustrates a screen that is displayed on display 104 when the consumer selects “SEARCH NEARBY” on the screen shown in FIG. 4B. Map data is displayed, which includes two merchant indicators. A first merchant indicator indicates that two merchants at a first location are offering promotions in the shopping category. A second merchant indicator indicates that four merchants at a second location are offering promotions in the shopping category.

FIG. 4D illustrates a screen that is displayed on display 104 when the consumer selects the second merchant indicator on the screen shown in FIG. 4C. The names of the four merchants located at the second location are displayed. The consumer can request a promotional offer from one of the displayed merchants by selecting one of the merchant's names.

FIG. 4E illustrates a screen that is displayed on the display 104 when the consumer selects the merchant name “Merchant 1” on the screen shown in FIG. 4D. Promotional offer information is displayed indicating that the consumer can receive a ten percent discount on all items, and that the promotion offer ends on June 30, 2008. Merchant information is also displayed indicating a telephone number and an address associated with Merchant 1.

The consumer is given several options. The consumer has an option of selecting “CALL MERCHANT” to cause mobile communications device 102 to call the telephone number associated with Merchant 1. The consumer also has an option to select “SMS TO A FRIEND” to cause mobile communications device 102 to transmit the promotional offer information and merchant information to another consumer's mobile communications device. In one embodiment, the consumer may be presented with an option to send all or select promotional offers to another person's mobile communications device. Further, the consumer has an option to select “MAPS” to cause merchant's map data to be displayed on display 104. In addition, the consumer has an option cause mobile communications device 102 to store the promotional offer information and merchant information in a memory for later retrieval. In some embodiments, the consumer also has the option of selecting an icon to cause mobile communications device 102 to call a telephone number associated with a customer service department of a business that manages application server 108.

In one embodiment, memory requirements of mobile communications device 102 may be reduced by shifting features of the disclosed invention to other components such as, for example, application server 108. While many prior art mobile mapping systems require map data to be downloaded and saved within the memory of a mobile device, the present invention may receive map data on an “as needed” basis, therefore reducing the memory requirements of the mobile device. Practitioners will appreciate that more advance and efficient cell transmission protocols are emerging, which enable such receipt of complex data at a mobile device to occur very quickly.

FIG. 4F illustrates a screen that is displayed on the display 104 when the consumer selects “CUSTOMIZE” on the screen shown in FIG. 4A. The consumer could select “REORDER,” “SHOW,” and “HIDE” to order the categories of promotional offers according to the consumer's preferences. Categories of higher preference are ordered higher on the display than categories of lower preference. The consumer could select “DONE” to cause the mobile communications device 102 to send preference levels associated with each of the categories to the application server 108. The application server 108 stores the preference levels in the consumer's profile, which will be utilized by the application server 108 to select subsequently, requested promotional offers to ensure that the consumer only receives promotional offers that are of interest to the consumer.

In accordance with one embodiment, the mobile communications device may transmit a promotional offer or coupon to a POS reader in order to receive a discount, merchant rewards, free merchandise, etc. For example, on receiving a 20% off promotion offer from an electronic store, the consumer may select an option to have the offer transmitted to a POS system during checkout. In response, the POS deducts 20% from the purchase price. In another embodiment, the consumer may select an option to facilitate payment for an item using a balance of points from a loyalty account.

The present invention (i.e., mobile communications device 102; application server 108; or any part(s) or function(s) thereof) may be implemented using hardware, software, or a combination thereof, and may be implemented in one or more computer systems or other processing systems. Useful machines for performing some or all of the operations of the present invention include general-purpose digital computers or similar devices.

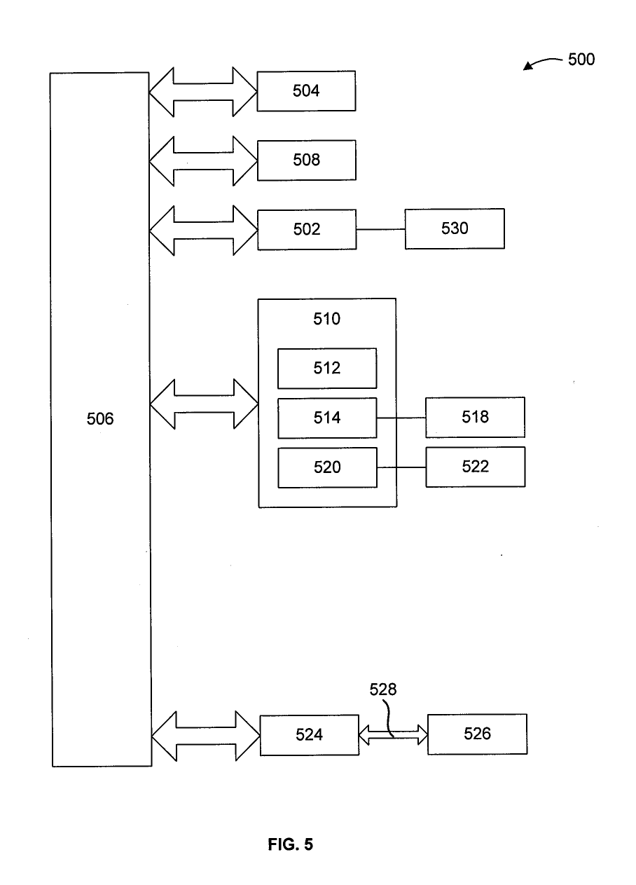

In fact, in one embodiment, the present invention is directed toward one or more computer systems equipped to carry out the functions described herein. An example of such a computer system 700 is shown in FIG. 5.

Computer system 700 includes at least one processor 704. Processor 704 is connected to a communication infrastructure 706 (e.g., a communications bus, a cross-over bar device, or a network). Although various software embodiments are described herein in terms of this exemplary computer system 700, after reading this description, it will become apparent to a person skilled in the relevant art(s) how to implement the invention using other computer systems and/or architectures.

Computer system 700 includes a display interface 702 that forwards graphics, text, and other data from communication infrastructure 706 (or from a frame buffer (not shown)) for display on a display unit 730. Computer system 700 also includes a main memory 708, which preferably is a random access memory (RAM), and may also include a secondary memory 710. Secondary memory 710 may include, for example, a hard disk drive 712 and/or a removable-storage drive 714 (e.g., a floppy disk drive, a magnetic tape drive, an optical disk drive, and the like). Removable-storage drive 714 reads from and/or writes to a removable storage unit 718 in a well-known manner. Removable storage unit 718 may be, for example, a floppy disk, a magnetic tape, an optical disk, and the like, which is written to and read by removable-storage drive 714. As will be appreciated, removable storage unit 718 includes a computer-usable storage medium having stored therein computer software and/or data.

In alternative embodiments, secondary memory 710 may include other similar devices for allowing computer programs or other instructions to be loaded into computer system 700. Such devices may include a removable storage unit 722 and an interface 720 (e.g., a program cartridge and a cartridge interface similar to those used with video game systems); a removable memory chip (e.g., an erasable programmable read-only memory (“EPROM”) or a programmable read-only memory (“PROM”)) and an associated memory socket; and other removable storage units 722 and interfaces 720 that allow software and data to be transferred from removable storage unit 722 to computer system 700.

Computer system 700 may also include a communications interface 724, which allows software and data to be transferred between computer system 700 and external devices (not shown). Examples of communications interface 724 may include a modem, a network interface (e.g., an Ethernet card), a communications port, a Personal Computer Memory Card International Association (“PCMCIA”) interface, and the like. Software and data transferred via communications interface 724 are in the form of signals 728, which may be electronic, electromagnetic, optical or another type of signal that is capable of being received by communications interface 724. Signals 728 are provided to communications interface 724 via a communications path 726 (e.g., a channel). Communications path 726 carries signals 728 and may be implemented using wire or cable, fiber optics, a telephone line, a cellular link, a radio-frequency (“RF”) link, or the like.

As used herein, the phrases “computer program medium” and “computer usable medium” may be used to generally refer to removable storage unit 718 used with removable-storage drive 714, a hard disk installed in hard disk drive 712, and signals 728, for example. These computer program products provide software to computer system 700. The present invention may be implemented or embodied as one or more of such computer program products.

Computer programs (also referred to as computer control logic) are stored in main memory 708 and/or secondary memory 710. The computer programs may also be received via communications interface 724. Such computer programs, when executed, enable computer system 700 to perform the features of the present invention, as discussed herein. In particular, the computer programs, when executed, enable the processor 704 to perform the features of the present invention. Accordingly, such computer programs represent controllers of computer system 700.

In an embodiment where the present invention is implemented using software, the software may be stored in a computer program product and loaded into computer system 700 using removable-storage drive 714, hard drive 712, or communications interface 724. The control logic (software), when executed by processor 704, causes processor 704 to perform the functions of the present invention as described herein.

In another embodiment, the present invention is implemented primarily in hardware using, for example, hardware components such as application-specific integrated circuits (“ASICs”). Implementation of such a hardware arrangement so as to perform the functions described herein will be apparent to persons skilled in the relevant art(s). In yet another embodiment, the present invention is implemented using a combination of both hardware and software.

As will be appreciated by those of skill in the relevant art(s), the present invention may be implemented using a single computer or using a computer system that includes multiple computers each programmed with control logic to perform various of the above-described functions of the present invention.

It should be understood that the attached drawings, which highlight the functionality and advantages of the present invention, are presented as illustrative examples. The architecture of the present invention is sufficiently flexible and configurable, such that it may be utilized (and navigated) in ways other than that shown in the drawings.

Further, the purpose of the appended Abstract is to enable the U.S. Patent and Trademark Office and the public generally, and especially scientists, engineers, and practitioners in the relevant art(s), who are not familiar with patent or legal terms and/or phraseology, to determine quickly from a cursory inspection the nature and essence of the technical subject matter disclosed herein. The Abstract is not intended to be limiting as to the scope of the present invention in any way.

Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of any or all the claims or the invention. As used herein, the terms “includes”, “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical”.

We claim:

1. A method for providing a promotional offer to a mobile communications device based on a location of the mobile communications device, the method comprising:
receiving a location identifier from the mobile communications device;
transforming the location identifier and preference information associated with at least one of: a consumer identifier and the mobile communications device to a promotional offer identifier;
obtaining the promotional offer based upon the promotional offer identifier; and,
transmitting the promotional offer for use in a transaction to the mobile communications device.

2. The method of claim 1, wherein the preference information includes a plurality of preference levels for categories of promotional offers.

3. The method of claim 1, further comprising determining whether a consumer is interested in receiving the promotional offer based on a category associated with the promotional offer identifier and the consumer preference information.

4. The method of claim 1, further comprising transmitting at least one of: map data and a merchant indicator to the mobile communications device.

5. The method of claim 1, further comprising transmitting map data to the mobile communications device, wherein the map data includes a merchant indicator.

6. The method of claim 1, wherein the receiving the location identifier further comprises receiving at least one of: the consumer identifier and the preference information.

7. The method of claim 1, wherein the location identifier is a real-time location of the mobile communications device.

8. The method of claim 1, further comprising receiving consumer coordinates corresponding to the location identifier.

9. The method of claim 1, further comprising determining a distance from the location identifier to a location associated with the promotional offer identifier.

10. The method of claim 1, wherein the promotional offer is sent to a Point of Sale (POS) reader by the mobile communications device.

11. The method of claim 1, wherein the promotional offer is automatically sent to another mobile communication device.

12. The method of claim 1, wherein, upon receiving a consumer instruction, the promotional offer is sent to another mobile communication device.

13. The method of claim 1, further comprising:
receiving pre-approval data which qualifies a consumer to be able to agree to purchase an item without the use of payment information;
sending pre-approval status to the mobile communications device;
sending an offer for sale of the item to the mobile communications device;
receiving an indication of an agreement to purchase the item to initiate a purchase transaction; and,
sending a confirmation when the indication is accepted.

14. The method of claim 13, wherein the pre-approval data includes at least one of: a credit card name, credit card number, expiration date, telephone number, loyalty account information, and a postal code.

15. The method of claim 13, wherein the receiving the indication comprises receiving at least one of: a text message, a credit card name, credit card number, expiration date, telephone number, a postal code and a personal identification number (PIN).

16. The method of claim 1, further comprising:
receiving a request from a seller for a taxing authority based on a sales transaction between the seller and a consumer;
determining the taxing authority, from a plurality of tax authorities, by evaluating the request;
determining a tax rate imposed by the taxing authority;
transmitting to the seller the tax rate;
receiving at the tax information system a payment modality for authorization;
validating the payment modality; and
transmitting to the seller an authorization of the payment modality in response to the validating step.

17. The method of claim 16, wherein the evaluating the request comprises evaluating at least one of: a location of at least one of the consumer and the seller, description of the sales transaction, a tax status of at least one of the consumer and the seller, and a sales price.

18. The method of claim 1, wherein the location identifier is determined based on at least one of: a network cell identifier, Location Based Services (LBS), a Global Positioning System (GPS) satellite system signal, Network Assisted GPS, Enhanced Observed Time Difference methods, Cell Global Identity Timing Advance, or Uplink Time of Arrival.

19. The method of claim 1, wherein the preference information comprises a requested promotional offer identifier.

20. The method of claim 1, wherein the selecting further comprises selecting the promotional offer based on a transaction card type associated with the consumer identifier.

21. The method of claim 1, further comprising generating tracking information associated with the promotional offer identifiers.

22. The method of claim 1, further comprising:
generating tracking information associated with the promotional offer identifiers; and
updating the preference information based on the tracking information.

23. The method of claim 1, wherein the promotional offer includes at least one of: text, an image file, and a video file.

24. The method of claim 1, wherein the promotional offer indicates that incentive program information.

25. The method of claim 1, further comprising downloading a client application to the mobile communications device.

26. A method of claim 1, further comprising determining whether the consumer identifier is authentic.

27. A method for receiving a promotional offer at a mobile communications device based on a location of the mobile communications device, the method comprising:
sending a location identifier from the mobile communications device to a host, wherein the host transforms the location identifier and preference information associated with at least one of: a consumer identifier and the mobile communications device to a promotional offer identifier, and wherein the host obtains the promotional offer based upon the promotional offer identifier; and,
receiving the promotional offer at the mobile communications device.

28. A computer readable medium having stored thereon a plurality of instructions, the plurality of instructions comprising:
instructions to receive a location identifier from the mobile communications device;
instructions to transform the location identifier and preference information associated with at least one of: a consumer identifier and the mobile communications device to a promotional offer identifier;
instructions to obtain the promotional offer based upon the promotional offer identifier; and,
instructions to transmit the promotional offer for use in a transaction to the mobile communications device.

29. A system for providing a promotional offer to a mobile communications device based on a location of the mobile communications device, said system configured to:
receive a location identifier from the mobile communications device;
transform the location identifier and preference information associated with at least one of: a consumer identifier and the mobile communications device to a promotional offer identifier;
obtain the promotional offer based upon the promotional offer identifier; and,
transmit the promotional offer for use in a transaction to the mobile communications device.
